(19) United States
(12) Patent Application Publication
(10) Pub. No.: US 2014/0027016 A1
(43) Pub. Date: Jan. 30, 2014

(54) WOOD SPLITTING APPARATUS

(71) Applicant: Allan Olson, Osage, IA (US)

(72) Inventor: Allan Olson, Osage, IA (US)

(21) Appl. No.: 13/561,056

(22) Filed: Jul. 29, 2012

(51) Int. Cl. B27L 7/06

(52) U.S. Cl. 144/195.6; 144/195.1

(57) ABSTRACT

The present invention is a wood splitting apparatus that includes a trailer hitch that releasably couples the wood splitting apparatus to a vehicle, an oil reservoir that contains hydraulic oil to operate the wood splitting apparatus and a plurality of hydraulic control valves with a plurality of hydraulic hoses, where the hydraulic hoses extend from the hydraulic control valves to the oil reservoir and where the hydraulic control valves control a splitting wedge movably disposed on the second end of the wood splitting apparatus. The apparatus also includes a base table that receives a wood chunk that removably rests on the base table and a base trailer that transports the wood splitting apparatus with the vehicle.

### TECHNICAL FIELD & BACKGROUND

Wood splitting relatively large chunks of wood, can be extremely time consuming and may begin to take a physical toll on an individual splitting the relatively large chunks of wood. Presently, there are limited options in apparatuses that allow a user to split relatively large wood chunks effectively and with minimal effort.

The present invention generally relates to a wood processing apparatus. More specifically, the invention is a wood splitting apparatus.

It is an object of the invention to provide a wood splitting apparatus that utilizes a vertical tilt and a horizontal tilt to load a relatively large wood chunk to be split.

It is an object of the invention to provide a wood splitting apparatus that allows a user to utilize the wood splitting apparatus at a relatively well suited working height.

It is an object of the invention to provide a wood splitting apparatus that allows a relatively large wood chunk to be split with relatively less effort in contrast to a relatively more labor intensive traditional wood splitting apparatus.

What is really needed is a wood splitting apparatus that utilizes a vertical tilt and a horizontal tilt to load a relatively large wood chunk to be split that allows a user to utilize the wood splitting apparatus at a relatively well suited working height that allows a relatively large wood chunk to be split with relatively less effort in contrast to a relatively more labor intensive traditional wood splitting apparatus.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of a wood splitting apparatus, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

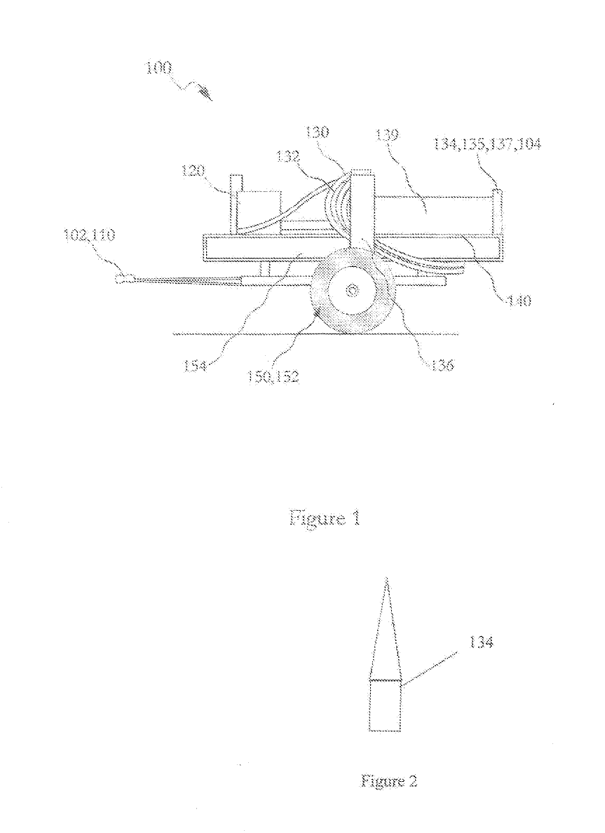

FIG. 1 illustrates a side view of a wood splitting apparatus 100, according to an embodiment of the present invention.

The wood splitting apparatus 100 includes a trailer hitch 110, an oil reservoir 120, a plurality of hydraulic control valves 130, a base table 140 and a base trailer 150. The trailer hitch 110 is disposed on a first end 102 of the wood splitting apparatus 100 and can be attached to any suitable vehicle such as a pick-up truck or a commercial truck (not shown). The oil reservoir 120 contains hydraulic oil and can contain approximately 10 gallons of hydraulic oil, although the oil reservoir 120 can contain any suitable quantity of hydraulic oil to operate the wood splitting apparatus 100. The hydraulic control valves 130 include a plurality of hydraulic hoses 132 extending from the hydraulic control valves 130 to the oil reservoir 120. The hydraulic control valves 130 control the operation of a splitting wedge 134 movably disposed on a second end 104 of the wood splitting apparatus 100. The splitting wedge 134 is a hydraulic splitting wedge 135 and is approximately up to 12 inches in height and is a two stage splitting wedge 137, although the splitting wedge 134 can be any suitable height and any suitable type of hydraulic splitting wedge such as a single stage splitting wedge. The splitting wedge 134 is capable of splitting up to an approximate 36 inch wood chunk 139 with up to an approximate 4 inch diameter cylinder. The base table 140 receives the wood chunk 139 where the wood chunk 139 removably rests on the base table 140. The base table 140 is designed with a hydraulic vertical tilt to allow a user to load wood chunks 139 in a vertical position, and then tilt the base table 140 back into a horizontal position to provide relatively easy loading.

The base table 140 is approximately 36 inches in length by 36 inches in width. The splitting wedge 134 then makes contact with the wood chunk 139 while the wood chunk 139 rests on the base table 140 and splits the wood chunk 139 by driving the splitting wedge 134 against a back stop plate 136. The hydraulic hoses 132 extend from the hydraulic control valves 130 to the splitting wedge 134. The back stop plate 136 holds the wood chunk 139 by pressure as the splitting wedge 134 drives into and through the wood chunk 139, thereby splitting the wood chunk 139 with the force from the splitting wedge 134 onto the wood chunk 139 against the back stop plate 136. The splitting wedge 134 horizontally drives into and splits the wood chunk 139 with a hydraulic force controlled by the hydraulic control valves 130. The base trailer 150 illustrated in FIG. 1 is a two wheel trailer 152 and has a top surfacing 154 but can be any suitable type of base trailer such as a 4 wheel base trailer. The oil reservoir 120, the hydraulic control valves 130 and the base table 140 are disposed on the top surfacing 154 of the base trailer 150. The base trailer 150 allows the wood splitting apparatus 100 to be transported by a suitable vehicle.

The wood splitting apparatus 100 is gasoline powered but can be powered by any suitable type of fuel such as an oil and gasoline fuel mixture or diesel fuel. The wood splitting apparatus 100 can be adjustably set at a well suited working height in order to minimize bending over and lifting, and once a wood splitting process has terminated, the wood splitting apparatus 100 also affords the user a convenient place for gathering the split wood in order to begin off-loading.

The wood splitting apparatus is a hydraulic wood splitter with an approximate 36 inches in length by 36 inches in width side table, capable of splitting up to an approximate 36 inch wood chunk with up to an approximate 4 inch diameter cylinder. The wood splitting apparatus is a well-suited alternative to similar traditional wood splitting apparatus products. The wood splitting apparatus is relatively easy to use. A user simply loads a relatively large wood chunk in front of a back stop plate and applies pressure to force up to a 12 inch two-stage wedge through the relatively large wood chunk. The wood splitting apparatus can be set at a well suited working height in order to minimize bending over and lifting, and once the wood splitting process has terminated, the wood splitting apparatus also affords the user a convenient place for gathering the split wood in order to begin off-loading. Among those who will find the wood splitting apparatus relatively practical and efficient are wood splitter manufacturers and an everyday user. The wood splitting apparatus features a gasoline engine powered hydraulic wood splitter with hydraulic control valves which sits on a two wheeled trailer for optimal portability. The wood splitting apparatus is designed with a hydraulic vertical tilt to allow operators to load large chunks of wood in a vertical position, and then tilt the wood splitter back into a horizontal position.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A wood splitting apparatus with a first end and a second end, comprising:
a trailer hitch disposed on said first end of said wood splitting apparatus, said trailer hitch releasably couples said wood splitting apparatus to a vehicle;
an oil reservoir that contains hydraulic oil to operate said wood splitting apparatus;
a plurality of hydraulic control valves with a plurality of hydraulic hoses, said hydraulic hoses extend from said hydraulic control valves to said oil reservoir, said hydraulic control valves control a splitting wedge movably disposed on said second end of said wood splitting apparatus;
a horizontally disposed base table having a fixed back stop plate disposed between the first end and the second end of said wood splitting apparatus, wherein said base table is adapted to receive a wood chunk, said wood chunk removably rests on said base table;
a base trailer with a top surfacing, said oil reservoir, said hydraulic control valves and said base table are disposed on said top surfacing of said base trailer, said base trailer transports said wood splitting apparatus with said vehicle;
wherein said hydraulic valves are configured to move the splitting wedge horizontally across said base table in a splitting direction defined as towards said first end; and
said back stop plate is configured to hold any wood chunk on said base table so as to prevent it from moving in the splitting direction, such that when the splitting wedge is moved in the splitting direction, it is driven into and through any wood chunk on said base table.

2.-3. (canceled)

4. The wood splitting apparatus according to claim 1, wherein said oil reservoir contains approximately 10 gallons of hydraulic oil.

5. (canceled)

6. The wood splitting apparatus according to claim 1, wherein said splitting wedge is a hydraulic splitting wedge.

7. The wood splitting apparatus according to claim 1, wherein said splitting wedge is a two stage splitting wedge.

8. The wood splitting apparatus according to claim 1, wherein said splitting wedge makes contact with said wood chunk while said wood chunk rests on said base table.

9. (canceled)

10. The wood splitting apparatus according to claim 1, wherein said base table is configured with a hydraulic vertical tilt structure adapted to allow a user to load said wood chunk in a vertical position and then tilt said base table back into a horizontal position to easily load said wood chunk.

11. A wood splitting apparatus with a first end and a second end, comprising:
a trailer hitch disposed on said first end of said wood splitting apparatus, said trailer hitch releasably couples said wood splitting apparatus to a vehicle;
an oil reservoir that contains hydraulic oil to operate said wood splitting apparatus;
a plurality of hydraulic control valves with a plurality of hydraulic hoses, said hydraulic hoses extend from said hydraulic control valves to said oil reservoir, said hydraulic control valves control a two stage hydraulic splitting wedge movably disposed on said second end of said wood splitting apparatus and said hydraulic hoses extend from said hydraulic control valves to said splitting wedge;
a horizontally disposed base table having a fixed back stop plate disposed between the first end and the second end of said wood splitting apparatus, wherein said base table is adapted to receive a wood chunk, said wood chunk removably rests on said base table;
a base trailer with a top surfacing, said oil reservoir, said hydraulic control valves and said base table are disposed on said top surfacing of said base trailer, said base trailer transports said wood splitting apparatus with said vehicle;
wherein said hydraulic valves are configured to move the splitting wedge horizontally across said base table in a splitting direction defined as towards said first end; and
said back stop plate is configured to hold any wood chunk on said base table so as to prevent it from moving in the splitting direction, such that when the splitting wedge is moved in the splitting direction, it is driven into and through any wood chunk on said base table.

12.-13. (canceled)

14. The wood splitting apparatus according to claim 11, wherein said oil reservoir contains approximately 10 gallons of hydraulic oil.

15. The wood splitting apparatus according to claim 11, wherein said splitting wedge makes contact with said wood chunk while said wood chunk rests on said base table.

16. (canceled)

17. The wood splitting apparatus according to claim 11, wherein said splitting wedge is capable of splitting up to an approximate 36 inch wood chunk.

18. The wood splitting apparatus according to claim 11, wherein said splitting wedge is approximately up to 12 inches in height.

19. The wood splitting apparatus according to claim 11, wherein said base table is configured with a hydraulic vertical tilt structure adapted to allow a user to load said wood chunk in a vertical position and then tilt said base table back into a horizontal position to easily load said wood chunk.

20. The wood splitting apparatus according to claim 11, wherein said base table is approximately 36 inches in length by 36 inches in width.
